(19) United States
(12) Patent Application Publication
(10) Pub. No.: US 2012/0245957 A1
(43) Pub. Date: Sep. 27, 2012

(54) METHOD AND APPARATUS FOR PROVIDING ELECTRONIC AFTERCARE INSTRUCTIONS

(75) Inventor: David J. MATHISON, Washington, DC (US)

(73) Assignee: healthEworks LLC, Washington, DC (US)

(21) Appl. No.: 13/426,044

(22) Filed: Mar. 21, 2012

Related U.S. Application Data
(60) Provisional application No. 61/454,851, filed on Mar. 21, 2011.

(51) Int. Cl. G06Q 50/24

(52) U.S. Cl. 705/3

(57) ABSTRACT

The apparatus and methods described provide aftercare instructions to a patient or patient caregiver (e.g., parent or guardian) upon releasing a patient from a hospital visit or other medical appointment. An electronic aftercare record may be created for a patient and used to track prescribed aftercare instructions that allows a medical practitioner to prescribe a targeted education plan to the patient/caregiver, and to deliver the targeted education electronically and instantaneously. In some aspects, aftercare instructions can be given following an acute illness or injury, or in anticipation of a problem or compliance at home.

### RELATED APPLICATIONS

The present Application for Patent claims priority to Provisional Application No. 61/454,851 entitled “Method and System for Method and System for Automating Healthcare Instructions” filed Mar. 21, 2011, the entirety of which is hereby expressly incorporated by reference herein.

### BACKGROUND

### Background

There exist in the art processes and procedures for providing patients with medical aftercare instructions. For example, when a patient is being discharged from a hospital emergency department (ED), the standardized process is to hand out a package of written information and instructions to the patient (or caregiver) being discharged, which includes the patient's diagnosis, and what actions, if any, the patient must perform in a home or other post-ED setting (e.g., what medications to take, home care demonstrations, signs for more care, etc.).

Certain factors, however, contribute to poor execution of discharge education, such as poor health literacy in some segments of the population, language and cultural barriers, and an increasing demand for electronic and/or web-based means of communication and data exchange, among other factors. As a result, many patients that are being discharged from EDs or other medical interactions fail to follow at least some part of the discharge instructions, and may fail to follow the discharge instructions altogether.

There is a need in the art, therefore, for methods and systems for to automate and customize medical aftercare instructions. Specifically, there is a need in the art for storing and tracking patient compliance with these instructions following a health encounter. Additionally, there is a need in the art for automating healthcare instructions using advanced multimedia and digital tools for standardized procedures or diagnoses, e.g., such as when a patient is discharged after a visit to a hospital ED or any other medical encounter. There is a further need in the art for methods and systems that would improve the success rate of implementing healthcare instructions and education, and for tracking the use and patient/caregiver compliance. There is yet a further need in the art to provide medical aftercare instructions that are easy to understand, and are delivered in an electronic and/or web-based format.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects, a method is presented for providing aftercare instructions. The method includes receiving a request for aftercare instructions, the instructions identifying a patient, creating a patient aftercare record associated with the patient, generating an electronic message including a reference to one or more aftercare instructions, the one or more aftercare instructions being specific to a diagnosis of the patient, transmitting the electronic message, and updating the patient aftercare record to indicate each access to the one or more aftercare instructions.

In accordance with some aspects, an apparatus is presented for aftercare instructions following a health encounter. The apparatus includes at least one processor and a memory coupled to the at least one processor. The at least one processor may be configured to receive a request for aftercare instructions, the instructions identifying a patient; create a patient aftercare record associated with the patient; generate an electronic message including a reference to one or more aftercare instructions, the one or more aftercare instructions being specific to a diagnosis of the patient; transmit the electronic message; and updating the patient aftercare record to indicate each access to the one or more aftercare instructions.

To the accomplishment of the foregoing and other ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a system implementing various aspects of the disclosure;

FIG. 2 depicts a method for providing aftercare instructions, in accordance with some aspects;

FIG. 3 depicts a method for tracking aftercare instruction access, in accordance with some aspects;

FIG. 4 depicts a user interface for enrolling a patient to receive electronic aftercare instructions, in accordance with some aspects;

FIG. 5 depicts an example of electronic aftercare instructions, in accordance with some aspects;

FIG. 6 depicts an example computer system, in accordance with some aspects; and

FIG. 7 depicts an example communication system, in accordance with some aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The apparatus and methods described herein provide aftercare instructions to a patient or patient caregiver (e.g., parent or guardian) upon releasing a patient from a hospital visit or other medical appointment with a healthcare provider, such as a physician, hospital, specialty clinic, surgery center, pharmacy clinic, physical therapy and rehabilitation center, urgent care center, dialysis facility, home healthcare agency, nursing home, call center, telemedicine, and/or any other healthcare provider. An electronic aftercare record may be created for a patient and used by the provider to track prescribed aftercare instructions that allows a medical practitioner to prescribe a targeted education plan to the patient/caregiver, and to deliver the targeted education electronically and instantaneously. In some aspects, aftercare instructions can be given following an acute illness or injury, or in anticipation of a problem or compliance at home.

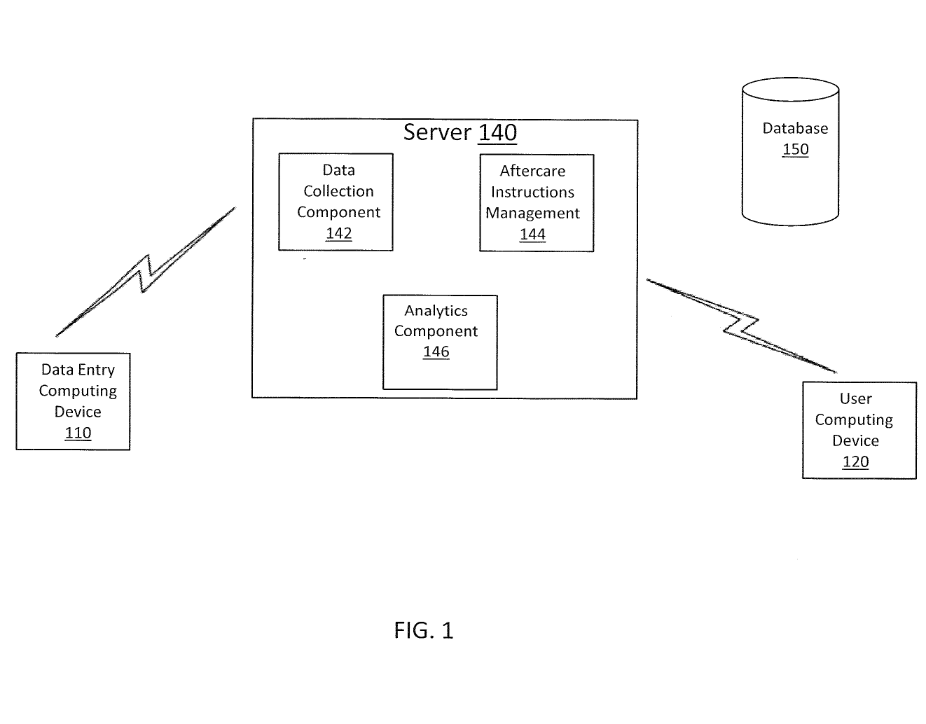

FIG. 1 depicts one example of a system 100 that may incorporate various aspects of this disclosure. System 100 may include one or more data entry computing devices 110 and one or more user computing devices 120 communicatively coupled to a server 140 via one or more networks. Each of data entry computing device 110 and user computing device 120 may be a wired or wireless computing device, such as a laptop computer, desktop computer, wireless phone, personal digital assistant (PDA), tablet computer, smartphone, and/or any other computing device capable of electronic communications with server 140. Networks may include, for example, a wireless network such as a WiFi or WLAN network, a cellular network such as CDMA, LTE, etc., a wired network, such as a LAN or WAN, and/or any other type of communication network.

Data entry computing device 110 may be used, for example, by a medical practitioner or his designee to input patient details, such as the patient's name, patient identification number, email address to which instructions should be sent, date of birth, and/or other patient information. In some aspects, data entry may be tied to an existing file associated with the patient, such as, for example, an electronic health record associated with the patient. In addition, the data entry computing device 110 may be configured to obtain consent of the patient to receive electronic aftercare instructions and/or other electronic mail. User computing device 120 may be used by patients to receive aftercare instructions. The instructions may be received via electronic mail (email), text message, etc., and may include, for example, multimedia, video, and/or other content specific to the patient's care. In some aspects, a patient may use more than one device to review the aftercare instructions. Additionally, a patient may specify one or more email addresses for receiving the aftercare instructions.

Server 140 may include a data collection component 142, an aftercare instructions management component 144, an analytics component 146, and/or other components. Data collection component 142 may be configured to receive the data input by the medical practitioner or designee to register a patient and request instructions. The data collection component 142 may facilitate storing patient records associated with each patient. In some aspects, patient records may be used to track aftercare instructions prescribed to a patient, and to track the patient's or caregiver's compliance with viewing/reading the instructions. Patient records may store information about each time the patient has a medical encounter. For example, the patient record may store entries for patient visits to a doctor's office or clinic, hospitalizations, diagnoses, treatments, prescribed after-care instructions, etc. Aftercare instructions management component 144 may be configured to retrieve the appropriate aftercare instructions, for example, from a database such as database 150, in response to a request for instructions. Aftercare instructions management component 144 may also be configured to generate an electronic message to the patient, or to the patient's caregiver, providing access to the selected aftercare instructions. Electronic messages providing access to the aftercare instructions may be sent via, for example, email, text message short message service (SMS), multimedia message service (MMS), etc. In some aspects, the aftercare instructions may comprise one or more streaming videos, and a link to the specific videos may be included in the electronic message, creating a “video prescription”. In other aspects, the electronic message may provide a link to a patient portal or other website, which may be used to access aftercare instructions. For example, a user may enter a user identifier and password to access a dedicated portal that provides instructions specific to the patient. The instructions may be in the form of multimedia instructions (such as video), text documents, diagrams, etc. In some aspects, the instructions may be provided via an interactive forum, such as, for example, a blog, online chat, etc.

Analytics component 146 may be configured to obtain and analyze data regarding the response of a user to the sending of aftercare instructions. Aftercare records may be created for each patient health encounter. The aftercare records may be stored individually, or all aftercare records for a patient from all health encounters may be stored in a combined record. The aftercare records may be stored in database 150 and/or any other storage entity accessible by server 140. For example, analytics component 146 may be configured to detect whether the electronic message was accessed, detect whether the prescribed instructions were accessed, detect the type of device used to access the videos, detect the number of times instruction is accessed, etc. These statistics may be used to inform medical practitioners and/or third parties (e.g., health insurance providers) of the effectiveness of the instructions. For example, in the case of video instructions, the analytics component 146 may be configured to detect the duration for which the video was played. In the case of a text document, analytics component 146 may be configured to detect whether the document was downloaded and/or opened. In accordance with some aspects, analytics component 146 may be configured to accept queries regarding a patient record. For example, analytics component 146 may accept queries from a medical practitioner to determine whether currently prescribed instructions have been accessed, whether instructions have historically been accessed, etc. In other aspects, the queries may be from a third party, such as an insurance company. For example, the insurance company may condition payment for treatment on compliance with aftercare instructions. Thus, a query to the analytics component 146 can be used to determine whether instructions were accessed.

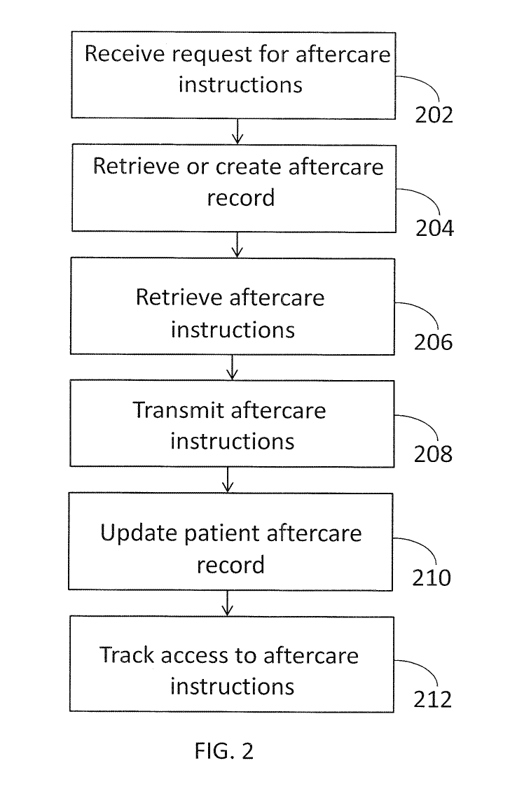

Turning now to FIG. 2, a method 200 is shown for providing aftercare instructions. The method may be performed, for example, by server 140. As shown at 202, a request to provide aftercare instructions may be received. In some aspects, at the time of discharge, a medical practitioner may initiate the request. In some aspects, the request may be generated after receiving an email message or telephone call from a patient describing, or providing images associated with a health condition. The request may identify the patient, including the name of the patient, date of birth, patient ID number, etc. In some aspects, the patient identifying information may be used to obtain a patient record associated with the patient, if the patient has an already established record, or in the case of a new patient, a new patient record may be created, as shown at 204. The patient record may include email addresses, telephone numbers, physical addresses, etc., associated with the patient. In some aspects, a patient aftercare record is created and stored for each patient health encounter. For example, a patient visiting an ED and receiving electronic aftercare instructions may have an aftercare record created specific to that ED visit, and may have another aftercare record created as a result of a visit to a specialty clinic. In some aspects, the aftercare records are stored separately. In other aspects, the aftercare records are stored in a combined patient aftercare record that tracks all health encounters of a particular patient. The combined patient aftercare record and/or the individual aftercare records may be associated with an existing electronic health record associated with the patient. In other aspects, the request includes one or more email addresses and/or telephone numbers to which electronic aftercare instructions should be sent. In addition to patient identifying information, the request may also identify the one or more aftercare instructions to be sent to the patient. In some aspects, particular instructions are specified in the request. In other aspects, a particular condition, as well as patient demographic information is specified in the request, and based on these parameters, server 140 can retrieve the appropriate aftercare instructions.

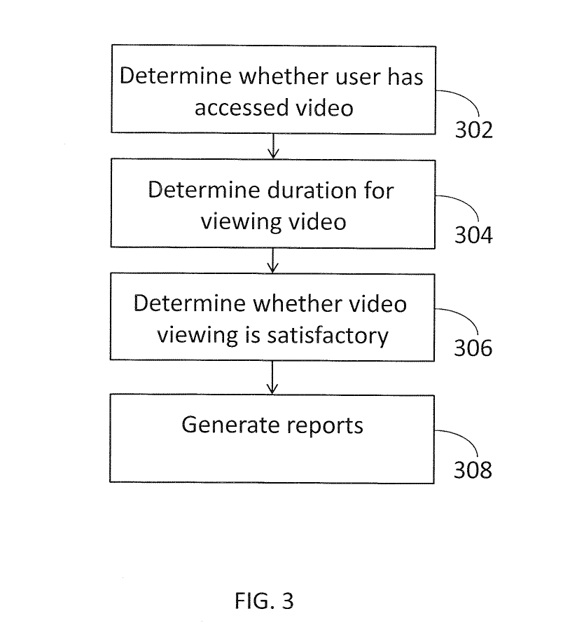

As shown at 206, the appropriate aftercare instructions are retrieved. The appropriate aftercare instructions are then transmitted to the email address, for example, associated with the patient, as shown at 208, and the patient record may be updated to reflect the newly prescribed instructions, as shown at 210 As depicted at 212, accessing the instructions may be tracked. Tracking the access if the instructions can be used to ensure that the patient is receiving the necessary information. On example of tracking is shown in greater detail in FIG. 3 with respect to video instructions. It is noted that tracking access to other types of instructions can be performed in a similar manner. For example, tracking may include detecting that a user has logged into a patient portal, engaged in an online chat, downloaded a document, image, drawing, etc. Logging the amount of interaction the user has with the instructions may be performed for any instruction type.

As depicted at 302, a determination is made as to whether a user has accessed the one or more videos included in electronic aftercare instructions prescribed. This may include, for example, detecting the date/time that the user has selected an option to view a video. Selecting an option to view a video may trigger a “video selected” indication message to the server. As shown at 304, once it has been determined that a video has been accessed, the duration for which the video is played may be tracked. This may include, for example, monitoring the video start and stop times. In accordance with some aspects, a threshold may be used to determine whether a video can be considered “viewed.” For example, if a video was played for at least 75% of its duration, it may be considered viewed. As shown at 306, a determination is made as to whether the video has been viewed. Reports may then be generated and transmitted, for example, to a medical practitioner, indicating whether or not the video was viewed, as shown at 308.

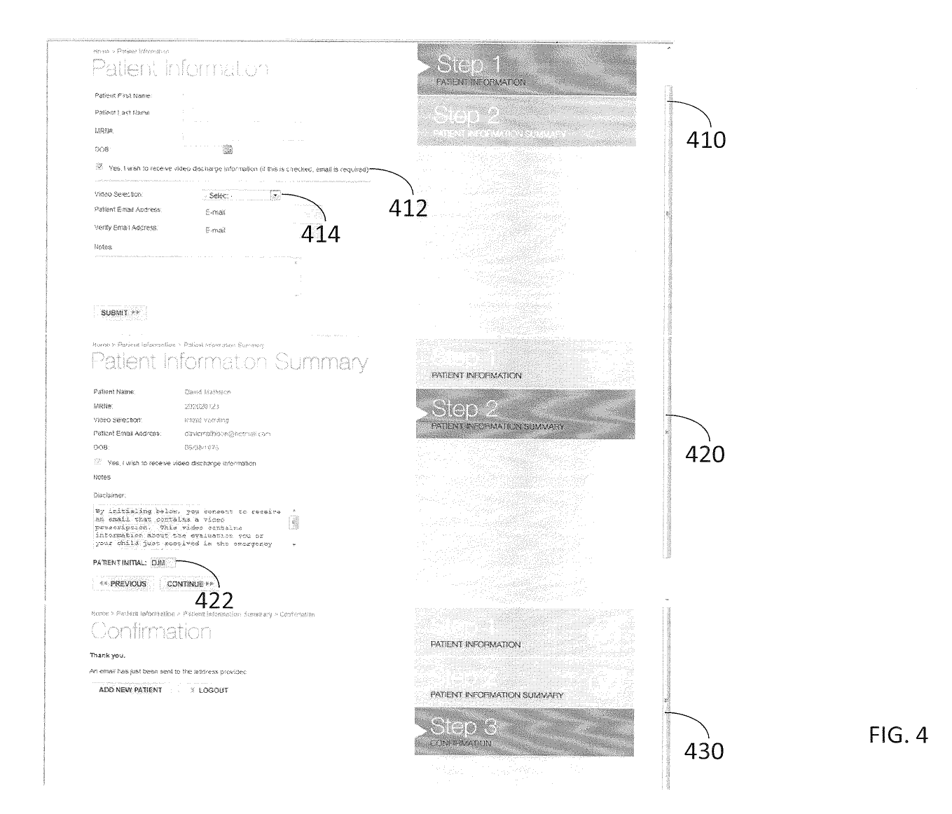

FIG. 4 illustrates a series of example dialogs that may be used to enroll a patient to receive electronic aftercare instructions. As shown at 410, a first screen may be presented for entering patient information. In some aspects, the information may be entered by a medical practitioner or designee, by a patient, or by both the medical practitioner and the patient. Information entered may include the name of the patient, date of birth, and email address. An option 412 may be presented enabling the patient to agree to receive electronic aftercare instructions. An option 414 may also be presented for selecting one or more aftercare instructions.

As shown at 420, a summary of the entered information may be provided. The summary screen may also include an option 422 for the patient to confirm that the patient is consenting to receive the electronic aftercare instructions. For example, the patient may be prompted to enter the patient initials to indicate consent. As shown at 430, a confirmation may be provided that the email including the aftercare instructions has been sent.

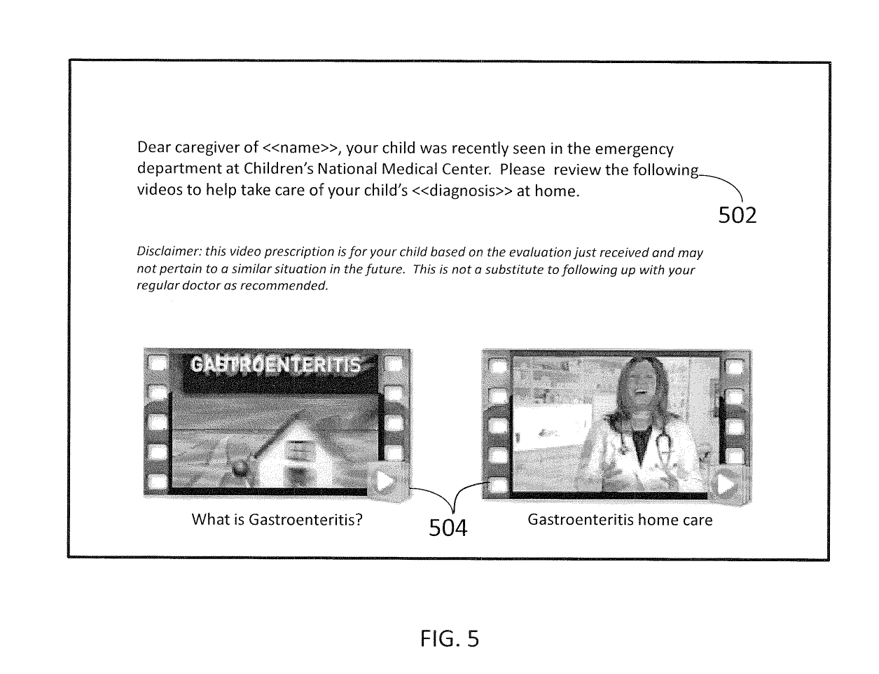

Turning now to FIG. 5, an example of an email message providing electronic aftercare instructions is shown. The email message may include an introduction 502 that identifies the patient. The email message may include one or more embedded videos 504 specific to the diagnosis of the patient. While embedded videos are shown, this is merely one example. For example, in some aspects, other types of aftercare instructions such as diagrams, images, text, and/or links to such instructions may be included in an email message.

The aftercare videos may be in any video format such, as for example, .wav, .mp3, .mp4, .avi, etc. The videos may be optimized for viewing on portable electronic devices. In some aspects, the type of device being used to view the videos may be detected, and the videos may be streamed to the user in a format compatible with the viewing device. The videos may provide information such as the meaning of a diagnosis, required home care, signs to return for additional medical attention, etc. The videos may be offered in multiple languages. In some aspects, the patient/caregiver may be asked to choose a language upon consenting to receive the videos. The videos may include procedural demonstrations, bullet points depicting important topics, anatomy basics, graphics, etc., to aid a user in understanding the information regardless of educational level. In some aspects, the videos may include interactive components. For example, the videos may be provided such that a user can choose sections of the video to view, answer questions, skip sections, request additional information, and/or any other interactive component. The selections made by the user may be stored in the associated patient aftercare record.

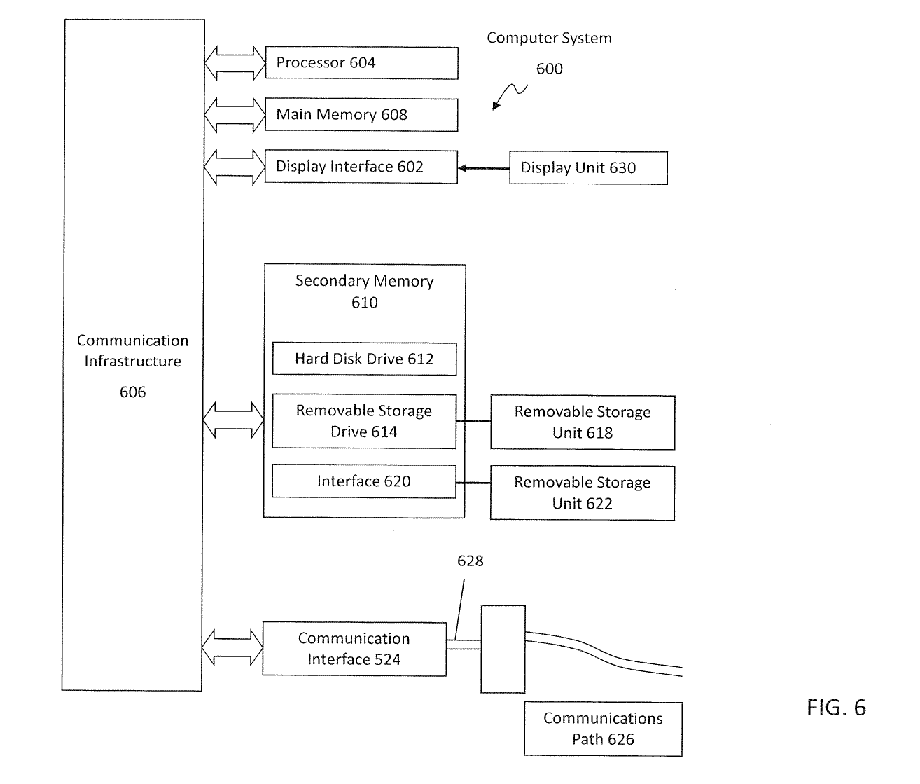

In some variations, aspects of the present invention may be directed toward one or more computer systems capable of carrying out the functionality described herein. An example of such a computer system 600 is shown FIG. 6.

Computer system 600 includes one or more processors, such as processor 604. The processor 604 is connected to a communication infrastructure 606 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

In alternative aspects, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 614, a hard disk installed in hard disk drive 612, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features of the present invention. Accordingly, such computer programs represent controllers of the computer system 600.

In an aspect where the invention is implemented using software, the software may be stored in a computer program product and loaded into computer system 600 using removable storage drive 614, hard drive 612, or communications interface 620. The control logic (software), when executed by the processor 604, causes the processor 604 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

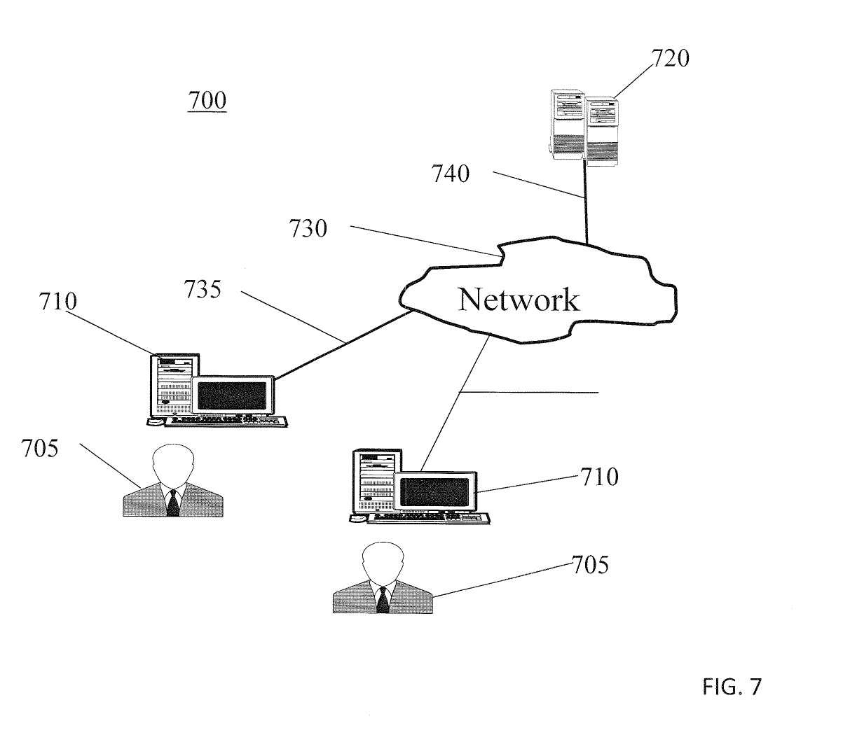

FIG. 7 shows a communication system 700 involving use of various features in accordance with aspects of the present invention. The communication system 700 includes one or more assessors 705 (also referred to interchangeably herein as one or more “users”) and one or more terminals 710 accessible by the one or more accessors 705. In one aspect, operations in accordance with aspects of the present invention is, for example, input and/or accessed by an accessor 705 via terminal 710, such as personal computers (PCs), tablets, minicomputers, mainframe computers, microcomputers, telephonic devices, or wireless devices, such as personal digital assistants (“PDAs”) or a hand-held wireless devices coupled to a remote device 720, such as a server, PC, minicomputer, mainframe computer, microcomputer, or other device having a processor and a repository for data and/or connection to a repository for data, via, for example, a network 730, such as the Internet or an intranet, and couplings 735, 740. The couplings 735, 740 include, for example, wired, wireless, or fiberoptic links. In another aspect, the method and system of the present invention operate in a stand-alone environment, such as on a single terminal.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a computing device which can be a wired computing device or a wireless computing device. A computing device can also be called a system, device, subscriber unit, subscriber station, mobile station, mobile, mobile device, remote station, remote terminal, access terminal, user terminal, terminal, communication device, user agent, user device, or user equipment (UE). A wireless computing device may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Moreover, the term “or” is intended to mean an inclusive “or” rather than an exclusive “or,” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for providing aftercare instructions following a health encounter, comprising:
receiving a request for aftercare instructions, the instructions identifying a patient;
creating a patient aftercare record associated with the patient;
generating an electronic message including a reference to one or more aftercare instructions, the one or more aftercare instructions being specific to a diagnosis of the patient;
transmitting the electronic message; and
updating the patient aftercare record to indicate each access to the one or more aftercare instructions.

2. The method of claim 1, wherein the request for aftercare instructions identifies the one or more aftercare instructions.

3. The method of claim 1, wherein the request for aftercare instructions identifies the diagnosis of the patient.

4. The method of claim 1, wherein the electronic message is an electronic mail (email) message.

5. The method of claim 1, wherein the electronic message is text message.

6. The method of claim 1, wherein the request includes one or more email addresses for transmitting the electronic message.

7. The method of claim 1, wherein the reference to the one or more aftercare instructions is a hyperlink to the one or more aftercare instructions.

8. The method of claim 1, further comprising:
obtaining consent from the patient to transmit to the electronic message.

9. The method of claim 1, wherein the one or more aftercare instructions comprise one or more videos, the method further comprising:
determining whether the one or more videos are accessed; and
upon determining that the one or more videos have been accessed, tracking a viewing duration for the one or more videos.

10. The method of claim 10, further comprising:
detecting a date and time when the one or more videos are accessed.

11. The method of claim 10, wherein at least one of the one or more aftercare instructions comprises one or more of a text message, a link to an interactive website providing instructions, a link to a patient portal, or a video presentation.

12. The method of claim 1, further comprising:
tracking access to the one or more aftercare instructions.

13. The method of claim 12, further comprising:
receiving a request to determine whether an aftercare instruction for a patient has been accessed; and
accessing the patient aftercare record to determine whether the aftercare instruction for the patient has been accessed.

14. The method of claim 12, further comprising:
generating a report indicating access of the one or more aftercare instructions.

15. An apparatus for providing aftercare instructions following a health encounter, comprising:
at least one processor configured to receive a request for aftercare instructions, the instructions identifying a patient; create a patient aftercare record associated with the patient, generate an electronic message including a reference to one or more aftercare instructions, the one or more aftercare instructions being specific to a diagnosis of the patient; transmit the electronic message; and update the patient aftercare record to indicate each access to the one or more aftercare instructions; and
a memory coupled to the at least one processor.

16. The apparatus of claim 15, wherein the request for aftercare instructions identifies the one or more aftercare instructions.

17. The apparatus of claim 15, wherein the request for aftercare instructions identifies a diagnosis of the diagnosis of the patient.

18. The apparatus of claim 15, wherein the electronic message is an electronic mail (email) message.

19. The apparatus of claim 15, wherein the electronic message is text message.

20. The apparatus of claim 15, wherein the request includes one or more email addresses for transmitting the electronic message.

21. The apparatus of claim 15, wherein the reference to the one or more aftercare instructions is a hyperlink to the one or more aftercare instructions.

22. The apparatus of claim 15, wherein the processor is further configured to:
obtain consent from the patient to transmit to the electronic message.

23. The apparatus of claim 15, wherein the one or more aftercare instructions comprise one or more videos, and wherein the processor is further configured to:
determine whether the one or more videos are accessed; and
upon determining that the one or more videos have been accessed, track a viewing duration for one or more videos.

24. The method of claim 23, wherein the apparatus is further configured to:
detect a date and time when the one or more videos are accessed.

25. The apparatus of claim 23, wherein at least one of the one or more aftercare instructions comprises one or more of a text message, a link to an interactive website providing instructions, a link to a patient portal, or a video presentation.

26. The apparatus of claim 15, wherein the processor is further configured to:
track access to the one or more aftercare instructions.

27. The apparatus of claim 26, wherein the processor is further configured to:
receive a request to determine whether an aftercare instruction for a patient has been accessed; and
access the patient aftercare record to determine whether the aftercare instruction for the patient has been accessed.

28. The apparatus of claim 26, wherein the processor is further configured to generate a report indicating access of the one or more aftercare instructions.

29. An apparatus, comprising:
means for receiving a request for aftercare instructions, the instructions identifying a patient;
means for creating a patient aftercare record associated with the patient;
means for generating an electronic message including a reference to one or more aftercare instructions, the one or more aftercare instructions being specific to a diagnosis of the patient;
means for transmitting the electronic message; and
means for updating the patient aftercare record to indicate each access to the one or more aftercare instructions.
